(19) United States
(12) Patent Application Publication
(10) Pub. No.: US 2007/0156554 A1
(43) Pub. Date: Jul. 5, 2007

(54) Method and Apparatus for Computer Assisted Settling of Debts

(76) Inventors: Richard L. NIKOLEY, San Jose, CA (US); Christopher Kelly, San Francisco, CA (US); Hugh F. Leo, Saratoga, CA (US)

Correspondence Address: GLENN PATENT GROUP, 3475 EDISON WAY, SUITE L, MENLO PARK, CA, 94025, US

(21) Appl. No.: 11/612,409

(22) Filed: Dec. 18, 2006

Related U.S. Application Data
(60) Provisional application No. 60/752,234, filed on Dec. 19, 2005.

(51) Int. Cl. G06Q 40/00

(52) U.S. Cl. 705/35

(57) ABSTRACT

A method and apparatus is provided for consumers to receive the recent settlement histories of their creditors in a web-hosted application that drives the settlement process, so they can use this insider knowledge to settle their debts for cents-on-the-dollar. One embodiment provides a computer assisted tool that tells consumers what their creditors take to settle debts for cents-on-the-dollar, and equips consumers to conduct the settlement process using a turn-key, web-hosted application; or alternatively provides a full-service embodiment that allows consumers to get immediate relief from collectors and be debt free in a matter of months rather than decades. The invention thus provides debtors with at least two principal competitive advantages: it provides debtors with knowledge in advance concerning how much credit card companies may take to settle their debts in view of their financial hardships; and it provides consumers with a turn-key method to settle their debts at discounts equivalent to those that professional negotiators could achieve.

### CROSS REFERENCE TO RELATED APPLICATIONS

This application claims priority to U.S. provisional patent application Ser. No. 60/752,234, filed Dec. 19, 2005, which application is incorporated herein in its entirety by this reference thereto.

### BACKGROUND OF THE INVENTION

1. Technical Field

The invention relates to credit and related financial transactions. More particularly, the invention relates to a method and apparatus for computer assisted settling of debts.

2. Description of the Prior Art

General Overview Of The Credit Card industry

Credit card debt in the U.S. exceeds $750 Billion, averaging approximately $12,000 per household. It is distributed among 64 million households, and 38 million of those make only minimum payments each month. At this rate it can take them as long as 55 years to repay their credit card debts, costing over four times the price of whatever they originally purchased.

Most credit card companies have pegged minimum monthly payments at 2% of the full balance then due. However, the Comptroller of the Currency is now pushing these creditors to increase their monthly minimums to 3% or even 4% of the full balances then due. This is putting 38 million households, carrying some $450 billion in credit card debt, in peril of losing their ability to stay even current in their minimum payments.

Credit card companies usually charge defaulting consumers substantial fees and increase their interest rates as well. This can easily create a cascading financial disaster for the consumers thus affected, many of whom were reduced to making only the minimum payments months or years earlier due to valid financial hardships they could neither reasonably foresee nor easily mitigate.

When consumers can no longer stay consistently current they fall within the domain of the collectors. According to the findings of the U.S. Congress, “There is abundant evidence of the use of abusive, deceptive, and unfair debt collection practices by many debt collectors. Abusive debt collection practices contribute to the number of personal bankruptcies, to marital instability, to the loss of jobs, and to invasions of individual privacy.” In response to these findings Congress passed the Fair Debt Collection Practices Act (FDCPA) that is honored more in its breach than in its observance.

The Marketing And Collection Posture Of The Credit Card Industry

To maximize profits and outperform their competitors, credit card companies aggressively market their services, knowing that some consumers will not be able to repay their balances.

The companies freely adopt these practices, recognizing they will lead to a “cost of doing business” from losses when balances due are beyond some customers' means to repay. Still the credit card industry as a whole earns over $30 Billion in profits in a single year.

Credit card companies accept these losses as a price they must pay to win a larger share of the profits available to the industry as a whole. Of course, they do not accept losses casually. They pursue collection efforts vigorously, assuming the consumer is “guilty until proven innocent.”

Creditors accept losses only as a last resort, after a clear demonstration that repayment in full is truly beyond the consumer's means. What credit card companies view simply as a cost of doing business can ruin the lives of consumers who cannot afford to repay their debts in full.

Obtaining Debt Relief

Consumers face a myriad of obstacles in obtaining debt relief from their creditors, most notably the credit card companies their collectors, agents and successors in interest.

Does The Consumer Qualify For Debt Settlement?

Consumers need to evaluate whether they qualify to reduce their debts through negotiated debt settlements with their creditors. Creditors will accept less than the full amount due in settling debts only when they conclude it is better for them to receive the lesser settlement amount now than to continue collection efforts in the uncertain hope of receiving more at some indeterminate time in the future, when any additional amount collected might easily have been consumed by legal and collection costs along the way. The calculus of the creditor's decision-making concerning the consumer's qualification for debt settlement is beyond the knowledge and experience of the ordinary consumer.

What Will The Creditors Accept To Settle The Consumer's Debts?

Consumers who may qualify for debt settlement must somehow determine how many cents-on-the-dollar their creditors will accept to settle their debts. For the most part this information is available only to industry insiders. Beyond that the information is subject to a high rate of change over short spans of time, to wide variability across the full range of creditors and to apparent inconsistencies absent an informed, nuanced understanding of the circumstances of both the consumer and the creditor at the time the settlement was negotiated.

In a negotiation knowledge is power. Relatively speaking the consumer is uninformed about these matters while trying to settle debts with their creditors. The creditors use their superior information to the disadvantage of the consumer seeking to settle their debts.

How Can The Consumer Match The Creditors' Negotiating Prowess?

Debt settlement is a process of negotiation with unsecured creditors to convince them to give up their demands for the full repayment of balances due and instead to accept a lesser amount, relieving the consumer of all obligation for further repayment once the lesser amount negotiated has been paid.

Negotiation is an acquired skill. Creditors are represented by professionals in the practice who have the experience of hundreds if not thousands of negotiations conducted personally plus the collective corporate memory setting guidelines and policies based upon the institution's overall experience of what strategies and tactics are most effective in negotiating settlements.

Consumers needing to settle their debts are facing negotiations of this sort ordinarily for the first time. An individual consumer has no repository of negotiating strategy, tactics and experience to match that of the creditors, honed by the natural selection of thousands of settlement negotiations.

With Whom Can The Consumer Negotiate?

Consumers reasonably think of the names of their creditors when they consider the debts they owe. However, when seeking debt relief the consumer may need to deal with the creditor or the creditor's collector, agent or successor in interest. The identity of the appropriate party changes as the collection process unfolds. The changes can occur many times. The one thing all of these parties has in common is that they want to collect 100 cents on the dollar not settle the debt with the consumer. Settlement is their last consideration, and ordinarily will not be pursued until other options have been pursued or at least evaluated and determined to be unfeasible. So the question for the consumer is actually twofold. With whom and when can the consumer conduct debt settlement negotiations?

In summary, debtors often spend decades paying the current monthly minimum payments due their creditors. Among the options for such debtors is enrolling in a traditional debt settlement program, engaging in do-it-yourself debt settlement and guessing what their creditors are prepared to accept to settle their debts, participating in credit counseling programs that have a 65% to 70% failure rate, borrowing more money to consolidate their debts, or declaring a bankruptcy that remains on their credit report for ten years. Credit card companies are often willing to negotiate with consumers who have financial hardships to settle their debts at a discount. It would be advantageous to provide a way for consumers to receive the recent settlement histories of their creditors, for example in a web-hosted application that drives the settlement process, so they can use this insider knowledge to settle their debts.

### SUMMARY OF THE INVENTION

Creditors have distinct advantages over consumers who need debt relief and who, accordingly, can no longer make the ongoing monthly payments required by the creditors, nor repay their balances due in full. Creditors both make the rules and apply them. Their choices in applying the rules amount to insider information generally unavailable to consumers, which creditors use to their advantage when negotiating debt collection and debt relief with consumers.

As a result consumers with financial hardships are unlikely to know:
whether they are entitled to debt relief;
what their creditors accept to settle debts;
how to engage effectively in a negotiating process to obtain debt relief;
who is the party with the authority to agree to settle their debts; and
how to document settlements so that they are binding upon the creditors and verifiable to third parties in the future.

The invention disclosed herein levels the playing field for consumers by:
aggregating information concerning the actual settlement experience from thousands of consumer accounts settled with creditors;
evaluating key characteristics of the consumer, the creditor, the account settled, and the actual settlement terms;
analyzing the relationships among key characteristics to draw inferences as predictors of creditors' future settlement behavior;
recommending to consumers a set of expectations to guide their settlement negotiations with each of their creditors, based upon the foregoing analysis;
providing consumers online tools to:
   organize and record all information required to conduct debt settlement negotiations;
   identify current creditor contacts who can negotiate debt settlements;
   create a record of communications with creditors during the debt settlement negotiation process; and
   compare tested settlement and related document templates to actual documentation supplied by creditors in the debt settlement negotiation process;
documenting actual debt settlements negotiated to conclusion by consumers to:
   provide consumers a fail-safe mechanism to record their settlements and to recover the documentation reflecting those settlements if needed for future verification; and
   to update the aggregation of information concerning the actual settlement experience from thousands of consumer accounts settled with creditors with additional and continually current new settlement information;
providing consumers working toward becoming debt free with online resources for:
   tabulating and evaluating their progress;
   general financial planning reference;
   budgeting;
   wealth building; and
   automatically converting the consumer's online debt settlement negotiating database to a full-service debt settlement program if the consumer finds negotiating directly with creditors to be unduly confusing or difficult, personally unsettling, or simply unproductive.

Thus, the preferred embodiment of the invention provides a way for consumers to receive the recent settlement histories of their creditors in a web-hosted application that drives the settlement process, so they can use this insider knowledge to settle their debts for cents-on-the-dollar. One embodiment provides a computer assisted tool that tells consumers what their creditors take to settle debts for cents-on-the-dollar, and equips consumers to conduct the settlement process using a turn-key, web-hosted application; or alternatively provides a full-service embodiment that allows consumers to get immediate relief from collectors and be debt free in a matter of months rather than decades. The invention thus provides debtors with at least two principal competitive advantages: it provides debtors with knowledge in advance concerning how much credit card companies may take to settle their debts in view of their financial hardships; and it provides consumers with a turn-key method to settle their debts at discounts equivalent to those that professional negotiators could achieve.

### BRIEF DESCRIPTION OF THE DRAWINGS

FIG. 1 is a screen shot showing a website that provides computer implemented tools for settling debt according to the invention;

FIG. 2 is a screenshot of a form showing consumer inputs to the website associated with the screen shot of. FIG. 1 according to the invention;

FIG. 2a is a spreadsheet showing consumer inputs to the form associated with the screen shot of FIG. 2 according to the invention;

FIG. 3 is a screenshot of a form showing a personal financial statement and illustrations of items to be charted, in response to the inputs provided by the consumer in FIG. 2, and pursuant to the website of FIG. 1 according to the invention;

FIG. 3a is a spreadsheet showing a personal financial statement and illustrations of items to be charted, in response to the inputs provided by the consumer in FIG. 2a according to the invention;

FIG. 4 is a screenshot of a form showing a case list according to the invention;

FIG. 5 is a screenshot of a form showing case details in connection with the case list shown in the screen shot of FIG. 4 according to the invention;

FIG. 6 is a screenshot of a form showing electronic payment transactions according to the invention;

FIG. 7 is a screenshot of a form showing employment hardship according to the invention;

FIG. 8 is a screenshot of a form showing a plurality of canned letters according to the invention;

FIG. 9 is a block diagram showing a process flow in connection with computer assisted settling of debts according to the invention;

FIG. 10 is a block schematic diagram of a system for determining an Anticipated Debt Settlement Ratio according to the invention;

FIG. 11 is a block diagram showing a process flow in connection with determining an Anticipated Debt Settlement Ratio according to the invention; and

FIG. 12 is a spreadsheet showing the results of applying the ADSR algorithm to two consumers having disparate sets of circumstances.

### DETAILED DESCRIPTION OF THE INVENTION

Creditors have distinct advantages over consumers who need debt relief and who, accordingly, can no longer make the ongoing monthly payments required by the creditors, nor repay their balances due in full. Creditors both make the rules and apply them. Their choices in applying the rules amount to insider information generally unavailable to consumers, which creditors use to their advantage when negotiating debt collection and debt relief with consumers.

As a result consumers with financial hardships are unlikely to know:
whether they are entitled to debt relief;
what their creditors accept to settle debts;
how to engage effectively in a negotiating process to obtain debt relief;
who is the party with the authority to agree to settle their debts; and
how to document settlements so that they are binding upon the creditors and verifiable to third parties in the future.

The invention disclosed herein levels the playing field for consumers by:
aggregating information concerning the actual settlement experience from thousands of consumer accounts settled with creditors;
evaluating key characteristics of the consumer, the creditor, the account settled, and the actual settlement terms;
analyzing the relationships among key characteristics to draw inferences as predictors of creditors' future settlement behavior;
recommending to consumers a set of expectations to guide their settlement negotiations with each of their creditors, based upon the foregoing analysis;
providing consumers online tools to:
   organize and record all information required to conduct debt settlement negotiations;
   identify current creditor contacts who can negotiate debt settlements;
   create a record of communications with creditors during the debt settlement negotiation process; and
   compare tested settlement and related document templates to actual documentation supplied by creditors in the debt settlement negotiation process;
documenting actual debt settlements negotiated to conclusion by consumers to:
   provide consumers a fail-safe mechanism to record their settlements and to recover the documentation reflecting those settlements if needed for future verification; and
   to update the aggregation of information in concerning the actual settlement experience from thousands of consumer accounts settled with creditors with additional and continually current new settlement information;
providing consumers working toward becoming debt free with online resources for:
   tabulating and evaluating their progress;
   general financial planning reference;
   budgeting;
   wealth building; and
   automatically converting the consumer's online debt settlement negotiating database to a full-service debt settlement program if the consumer finds negotiating directly with creditors to be unduly confusing or difficult, personally unsettling, or simply unproductive.

A preferred embodiment of the invention provides a way for consumers to receive the recent settlement histories of their creditors in a web-hosted application that drives the settlement process, so they can use this insider knowledge to settle their debts for cents-on-the-dollar. One embodiment provides a computer assisted tool that tells consumers What their creditors take to settle debts for cents-on-the-dollar, and equips consumers to conduct the settlement process using a turn-key, web-hosted application; or alternatively provides a full-service embodiment that allows consumers to get immediate relief from collectors and be debt free in a matter of months rather than decades. The invention thus provides debtors with at least two principal competitive advantages: it provides debtors with knowledge in advance concerning how much credit card companies may take to settle their debts in view of their financial hardships; and it provides consumers with a turn-key method to settle their debts at discounts equivalent to those that professional negotiators could achieve.

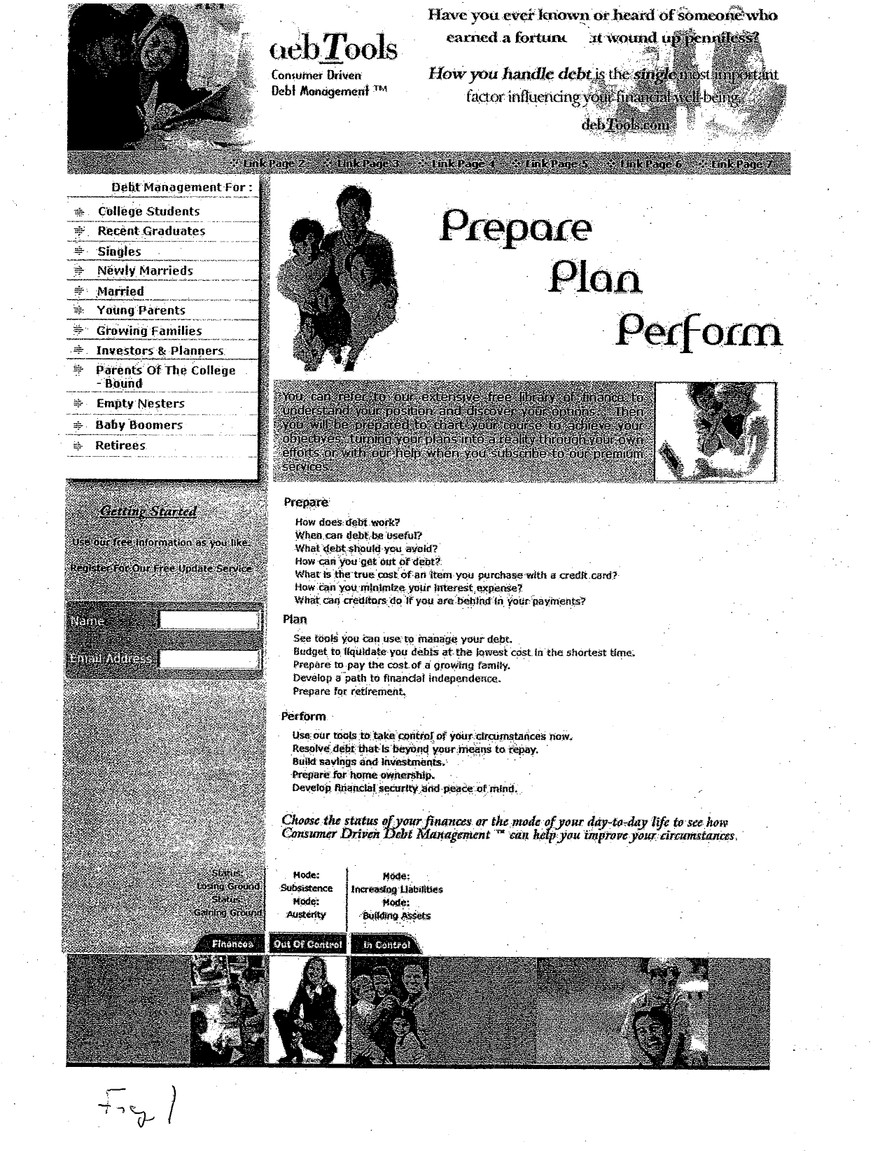

FIG. 1 is a screen shot showing a website that provides computer implemented tools for settling debt according to the invention. A consumer enters this website for access to various free and/or premium, i.e. for a fee, tools that assist the consumer in settling their debt and in learning to attain and maintain financial health.

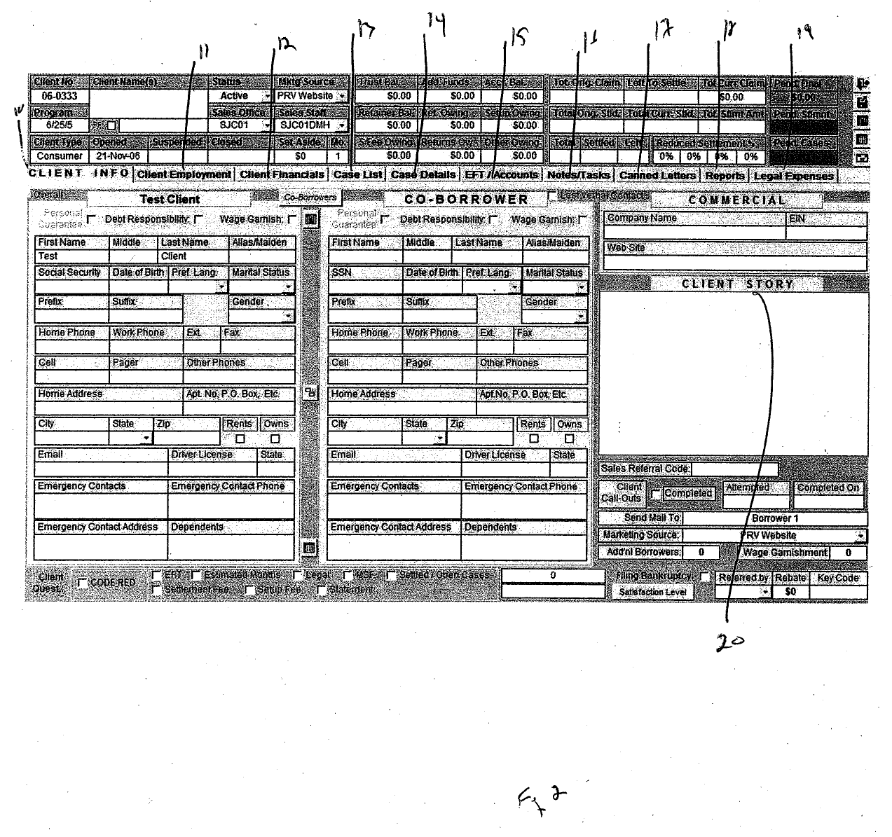

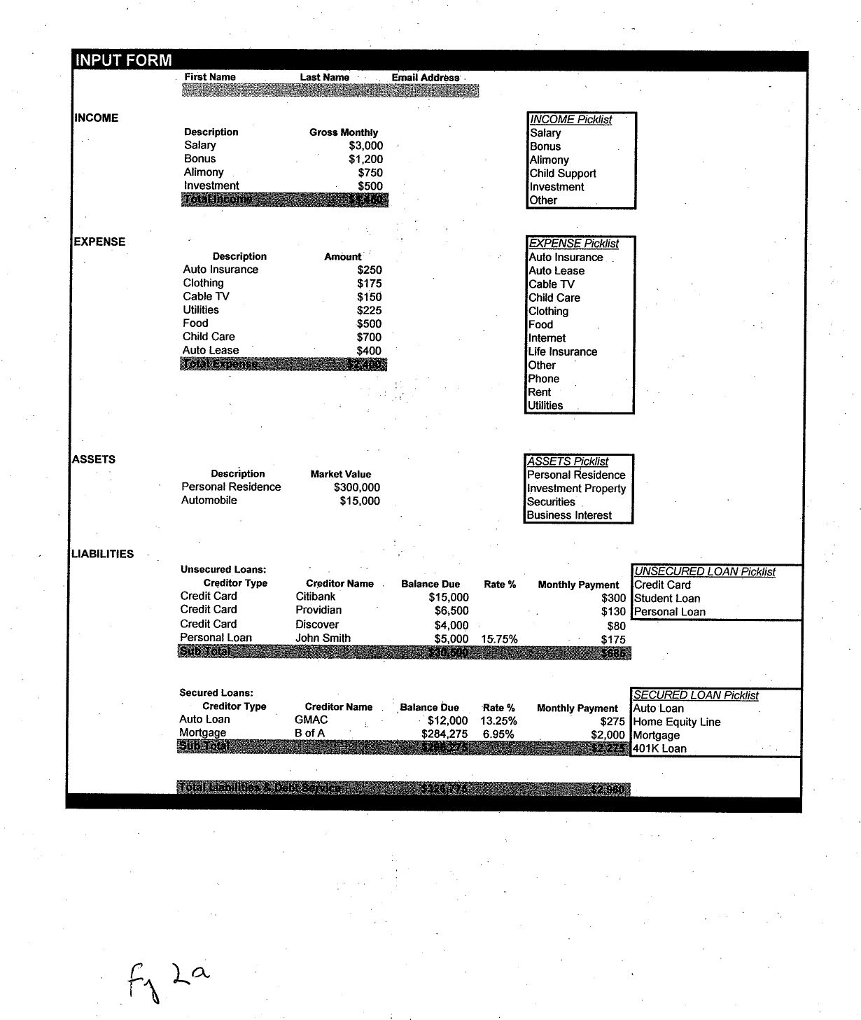

FIG. 2 is a form showing consumer inputs to the website associated with the screen shot of FIG. 1 according to the invention. The form includes user selectable tabs for Client Info 10, Client Employment 11, Client Financials 12, a Case List 13, Case Details 14, EFT Accounts 15, Notes/Tasks 16, Canned Letters 17, Reports 18, and Legal Expenses 19. A Client Story field 20 is also provided to allow the entry of a narrative in connection with the debtor's circumstances.

FIG. 2a is a spreadsheet showing consumer inputs to the form associated with the screen shot of FIG. 2 according to the invention.

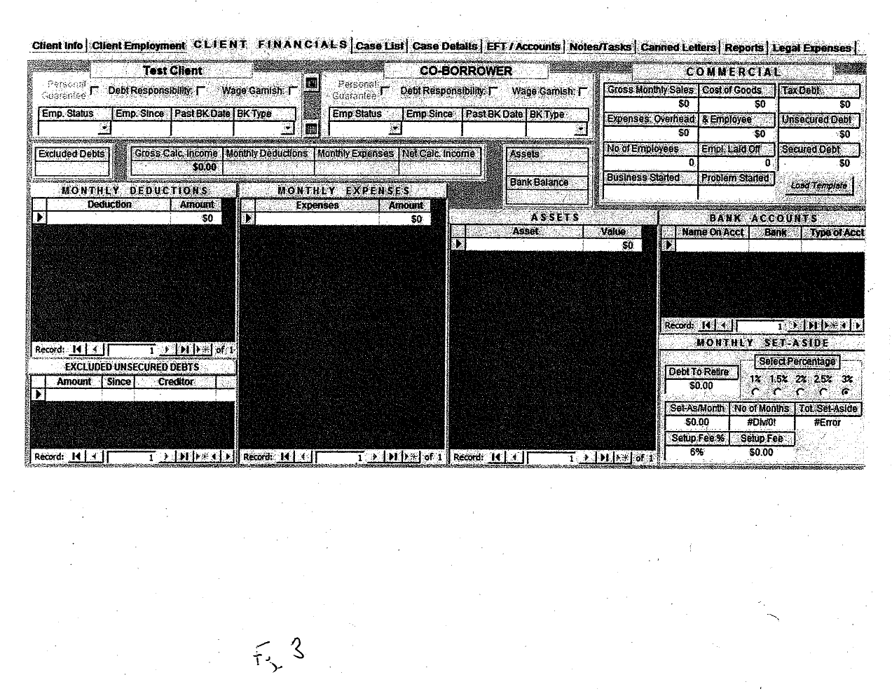

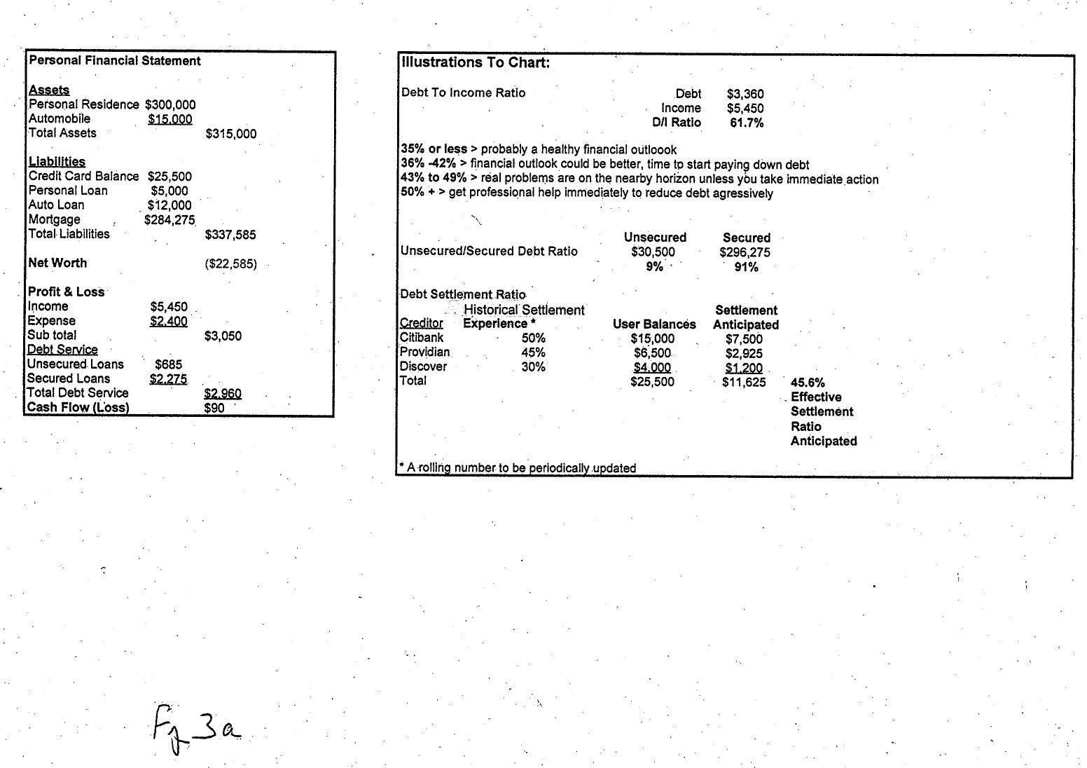

To use the tools provided by the invention, a debt ridden (or curious) consumer enters a set of information that is used by the invention to classify the consumer with regard to such factors a risk of bankruptcy and the like, as considered by a lender or credit provider when compromising upon amounts owed. The information shown in FIG. 2 is provided for purposes of example. In practice, more or less information may be required and/or provided in connection with the invention. In the example of FIG. 3A, the consumer has debt of $337,585.00 and the monthly cost of servicing this debt to the consumer is $2,960.00.

FIG. 3 is a form showing a personal financial statement and illustrations of items to be charted, response to the inputs provided by the consumer in FIG. 2, and pursuant to the website of FIG. 1 according to the invention. FIG. 3A is a spreadsheet showing a personal financial statement and illustrations of items to be charted, in response to the inputs provided by the consumer in FIG. 2a according to the invention.

In FIG. 3, the system has prepared a personal financial statement for the consumer, based upon the information provided by the consumer, as shown in FIG. 2. FIG. 3A provides various illustrations of outputs that would be charted to provide the consumer with an understanding of his likelihood of settling his debt. In the example of FIG. 3A, the consumer has a debt-to-income ratio of 61.7%, which indicates that the consumer should get financial help immediately to reduce debt aggressively. The consumer is also provided with information showing an unsecured/secured debt ratio and a debt settlement ratio. Key to the invention is the debt settlement ratio which shows the consumer experience-based settlement ratios for various creditors. The consumer is then provided with an anticipated settlement amount and an effective anticipated settlement ratio.

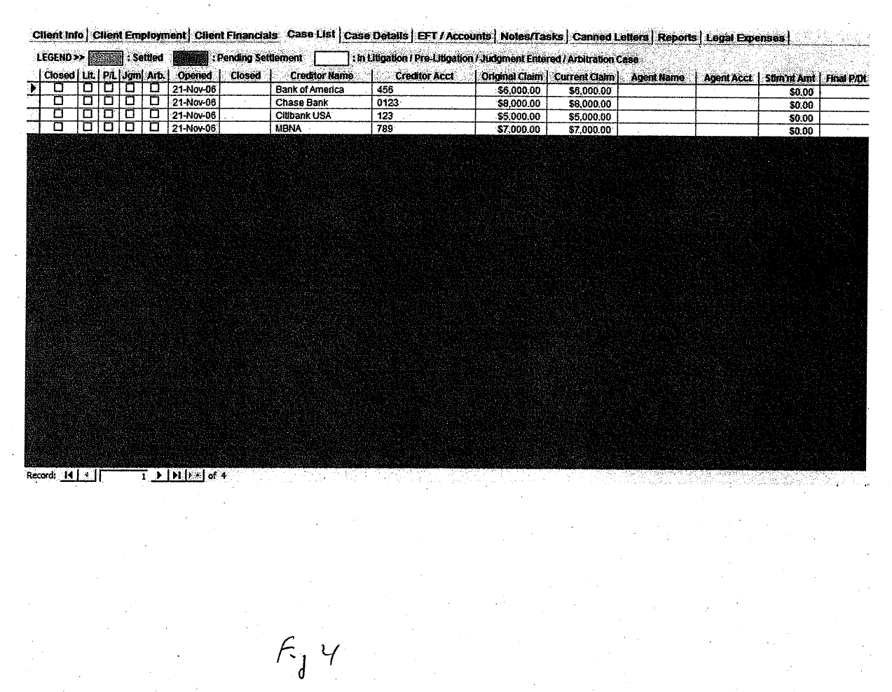

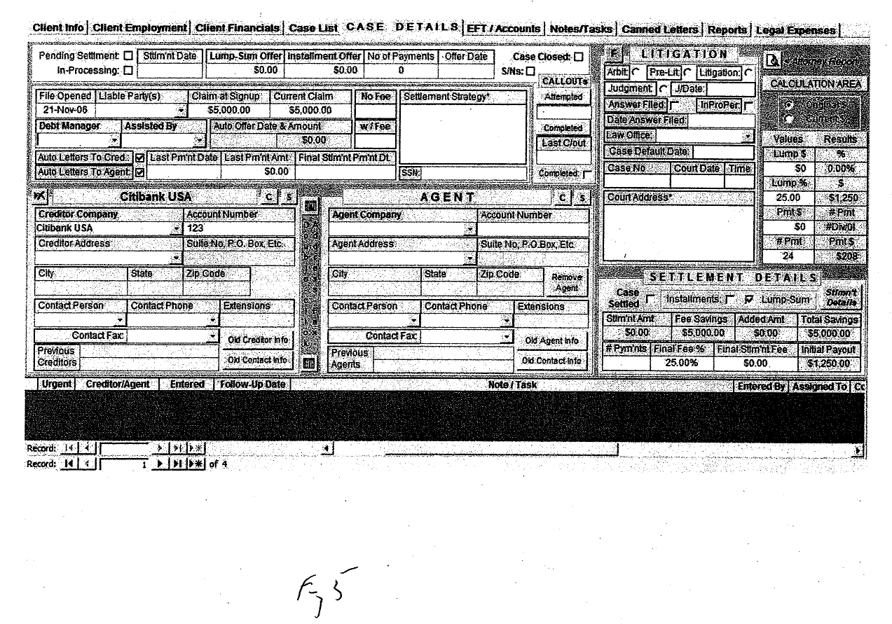

FIG. 4 is a screenshot of a form showing a case list according to the invention. In FIG. 4, a list of creditors and their respective claims is provided. FIG. 5 is a screenshot of a form showing case details in connection with the case list shown in the screen shot of FIG. 4 according to the invention. In particular, the claim for Citibank (fictional for purposes of example only) is shown in detail, including Settlement Details.

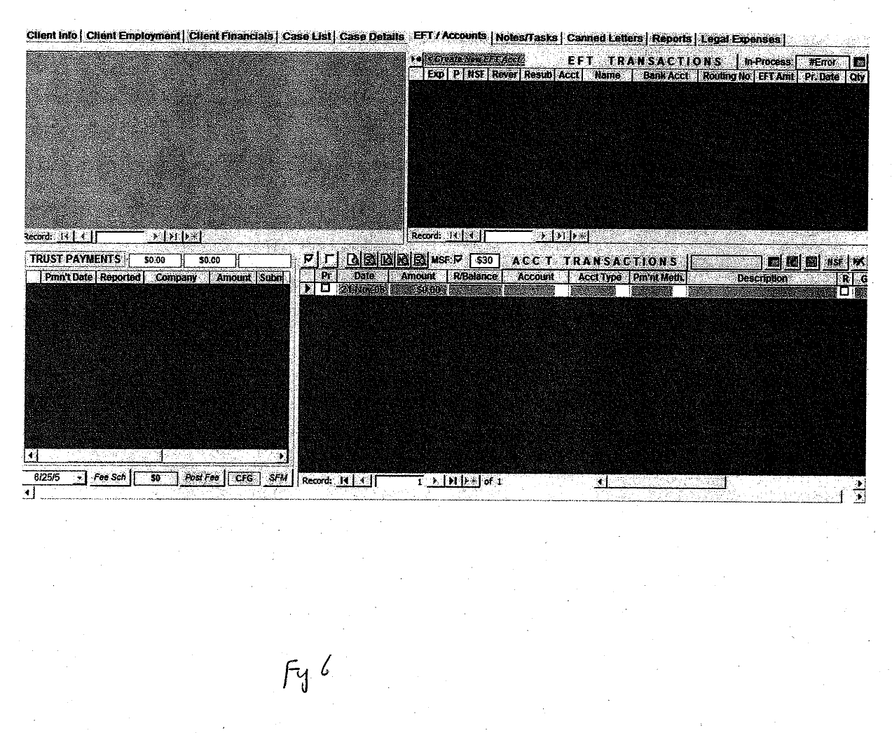

FIG. 6 is a screenshot of a form showing electronic payment transactions according to the invention. In this example, no transactions are listed.

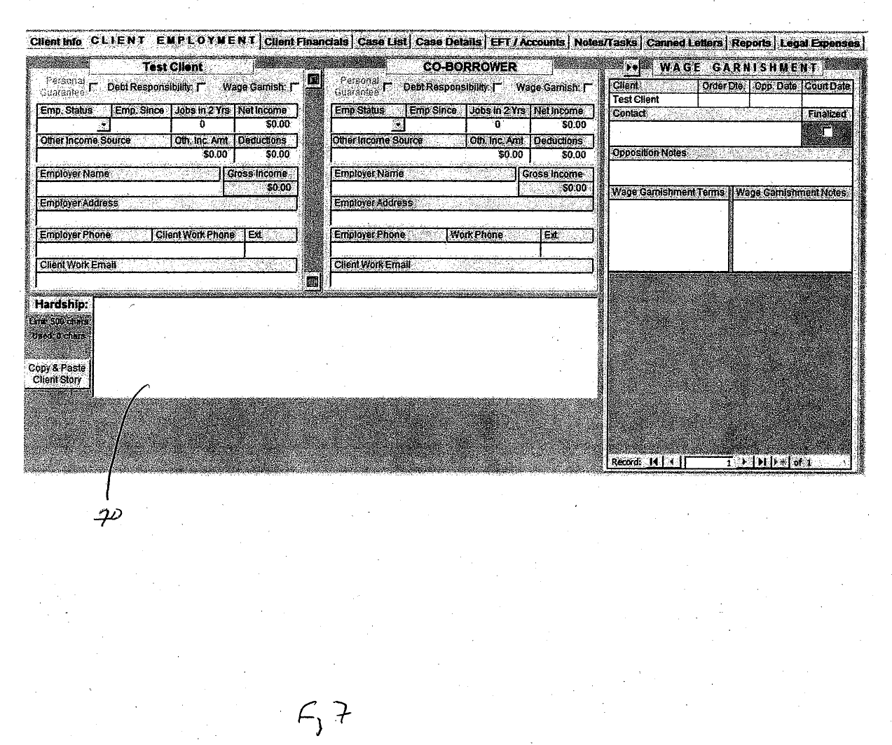

FIG. 7 is a screenshot of a form showing employment hardship according to the invention. In FIG. 7, a field 70 is provided that allows the entry of a narrative describing the debtor's circumstances.

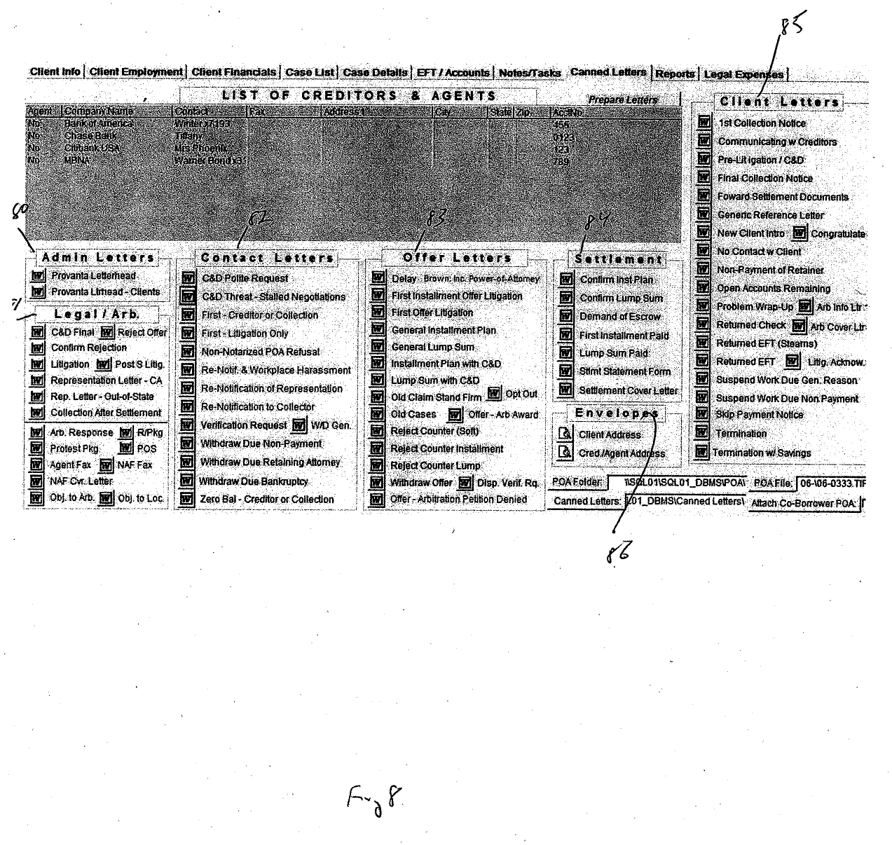

FIG. 8 is a screenshot of a form showing a plurality of canned letters according to the invention. In the example of FIG. 8, these letters are organized by category, e.g. Admin Letters 80, Legal/Arb(itration) letters 81, Contact Letters 82, Offer Letters 83, Settlement letters 84, Client Letters 85, and Envelopes 86.

Process Flow and Operation

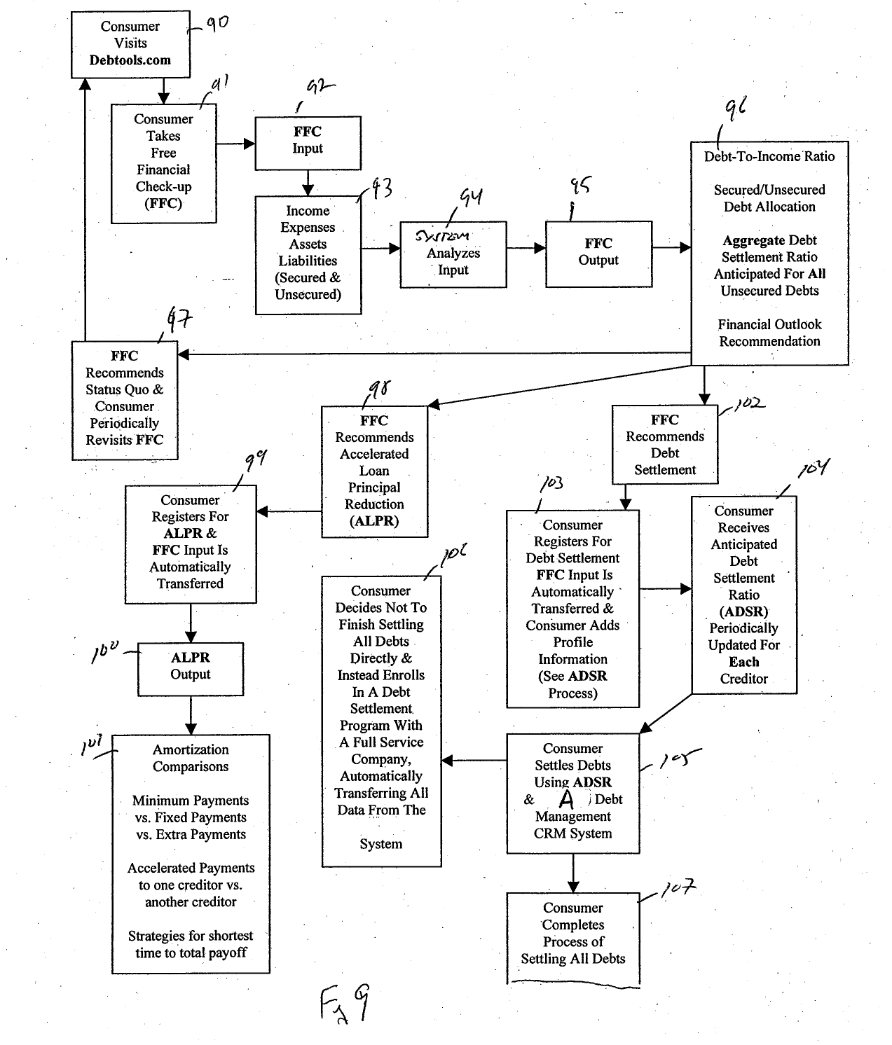

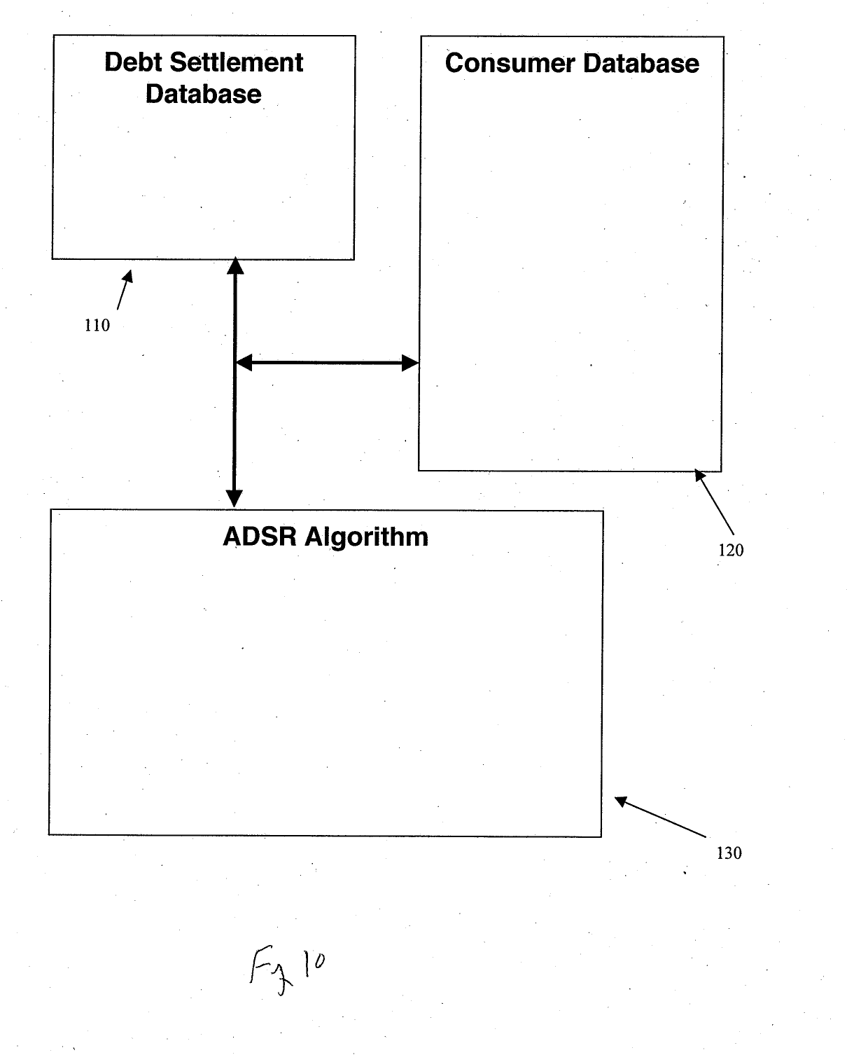

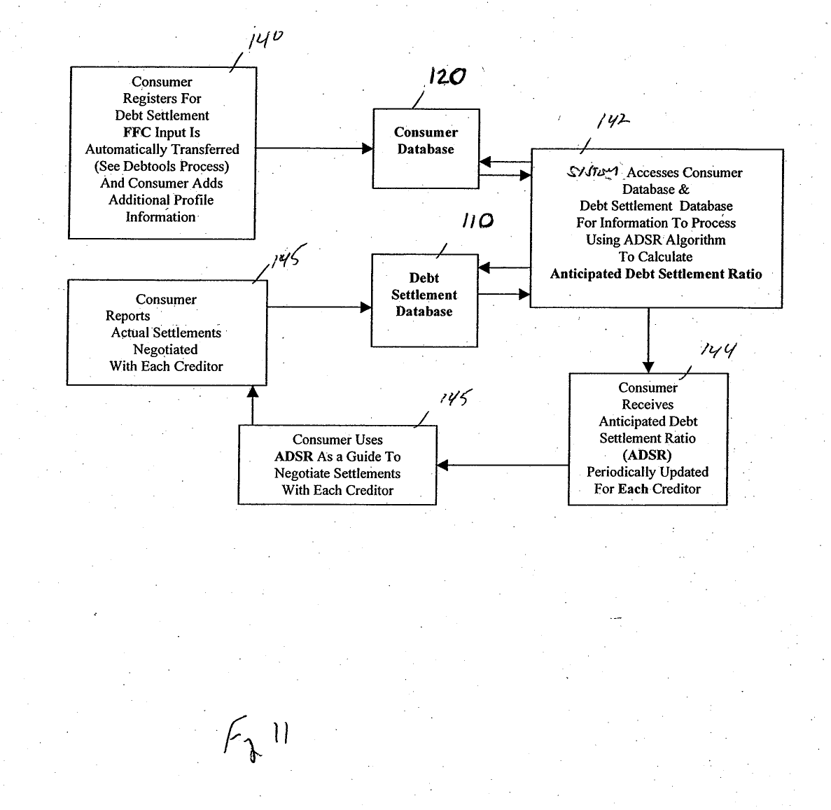

FIG. 9 is a block diagram showing a process flow in connection with computer assisted settling of debts according to the invention. In FIG. 9, At the start of the process, a consumer/debtor visits a website which incorporates the invention herein, such as Debtools.com (90). In the presently preferred embodiment, the consumer is offered a free financial check-up (FFC) (91). The FFC is input to the system (92). The FFC includes such information about the consumer as income, expenses, assets, and secured and unsecured liabilities (93). The system analyzes the consumer's input (94) and produces an FFC output (95). Output information includes a debt-to-income ratio, secured/unsecured debt allocation, an aggregate debt settlement ratio that is anticipated for all unsecured debts (ADSR; see FIGS. 10 and 11), and a financial outlook recommendation (96).

Possible outcomes of the FFC include:

Recommending that the consumer maintain the status quo and periodically visit the website (97). This recommendation would occur where the consumer is financially healthy or could not be helped by the tools afforded by the invention;

Recommending and accelerated loan principal reduction (ALPR) (98). In this case, the consumer registers for ALPR and the FFC input previously entered by the consumer is automatically transferred for processing (99) as an ALPR output (100). The consumer is then provided with such information as amortization comparisons, the effect of making minimum payments vs. fixed payments vs. extra payments, the effect of making accelerated payments to one creditor vs. another creditor, and strategies for the shortest time to total payoff of debt (101 ); and

Recommending debt settlement (102). In this case, the consumer registers for debt settlement and the FFC input previously entered by the consumer is automatically transferred for processing. Here, the consumer adds profile information per the ADSR process (discussed below) (103). The consumer receives an ADSR, which is periodically updated for each consumer (104). The consumer can then settle his debts using the ADSR and a debt management customer relations management (CRM) system (105). At this point the consumer has the option of completing the process of settling all debts (107) or the consumer can decide not to finish settling all debts directly and can, instead, enroll in a debt management program with a full service company, in which event all of the consumer's information is automatically transferred from the system to the full service company (106).

FIG. 10 is a block schematic diagram of a system for determining an Anticipated Debt Settlement Ratio (ADSR) according to the invention. Table 1 shows contents of the Debt Settlement Database (110), Table 2 shows contents of the Consumer Database (120), and Table 3 shows an exemplary ADSR Algorithm (130). The fields and data shown in Tables 1 and 2 are provided as an example and are not intended to be limiting with regard to the type and nature of information provided to, or collected by, the system.

TABLE 1

Creditor Name
File Opened Date
Settlement Date
Original Claim
Claim At Settlement
Settlement Amount
Settlement Ratio
Litigation Status
Total # Of Creditor's Claims
Total # Of Creditor's Settlements

TABLE 2

Personal Profile
Name
Age
Marital Status
Dependents
Employment Status
Financial Profile
Income
Expenses
Assets
Liabilities
Creditors
Balances Due
Monthly Payments
Delinquencies
Litigation Status
Hardship Profile
Employment/Income
Personal Health
Family
Solvency/Insolvency
Other

TABLE 3
The system maintains a Debt Settlement Database and a Consumer
Database. The databases associate debt settlements and consumers
owing the debts settled. The databases contain the information cited
above, referred to here as “characteristics.”
The Anticipated Debt Settlement Ratio is a percentage derived
by comparing:
the various characteristics of the debt in question to other debts actually
settled by the Creditor holding the debt in question, and
the various characteristics of the debt in question to similar debts actually
settled by other Creditors, and
the various characteristics of the Consumer owing the debt in question to
other Consumers whose debts were settled by the Creditor holding the
debt in question, and
the various characteristics of the Consumer owing the debt in question to
similar Consumers whose debts were settled by other Creditors.
The settlement ratios of the comparison settled debts thus derived are
weighted according to the relevance of the characteristic selectors. The
weighted ratios are then summed to produce the Anticipated Debt
Settlement Ratio for the debt in question.
“Relevance” is a factor that evolves based upon a continuing comparison
of the actual settlement ratio for a debt and the Anticipated Debt
Settlement Ratio for the same debt, derived in part by the effect of the
relevance factor applied in determining the ADSR for the debt in question.

FIG. 11 is a block diagram showing a process flow in connection with determining the ADSR according to the invention. To determine the ADSR a consumer first registers for debt settlement. FFC input is automatically transferred (see FIG. 9). The consumer adds additional profile information (140). Access is made to the consumer database 120. The system accesses the consumer database 120 and debt settlement database 110 for information to process, using the ADSR algorithm 130 to calculate the ADSR (142). The consumer receives the ADSR. The ADSR is periodically updated for each creditor of the consumer (144). The consumer uses the ADSR as a guide to negotiate settlements with each creditor (145). Finally, the consumer reports actual settlements that have been negotiated with each creditor to the debt settlement database (145).

Implementation Details

The following provides particular details with regard to practicing the invention. Those skilled in the art will appreciate that the actual choice of implementation is subject to the exercise of ordinary skill in the art and that the discussion herein provides sufficient details for the skilled person to implement the presently preferred embodiment of the invention. Modifications and variations in actual implementation are considered to be within the scope of the invention.

Consumer User Application

This embodiment of the invention provides a web interface that generally allows a consumer with any amount of debt (secured or unsecured) to enter their personal and financial information, along with details pertinent to each separate case and keep track of their progress in either paying down the debt or settling it outright.

This embodiment of the invention operates as follows:
1. Enter and store all standard pertinent contact information (address, phones, fax, email etc.) for the debtor and spouse.
2. Enter and store all financial information (employment, income, expenses, assets, liabilities) necessary to determine the user's financial solvency and cash flow position. Assist user in determining his tax bracket for use in calculating the tax impact in terms of cost (after tax vs. before tax dollars and depreciation recovery, etc.) or savings (deductions, depreciation, etc.).
3. With respect to liabilities, enter and store contact information pertinent to each debt/liability to enable regular contact via phone, fax, mail, email, and also to negotiate more favorable terms or settlements (owed, minimum payment amount, interest rate).
4. With respect to all of the above related to financial information, make maximum use of opportunities to educate users in financial matters as they enter data: the nature of the data, how it relates to other data, and how it can impact their financial health.

The consumer may hold secured debts (mortgages, cars, boats, RVs, etc.) as separate from unsecured debt, where the consumer may want to achieve accelerated pay-down on secured debts, while settling unsecured debt.

This embodiment of the invention comprises the following:
1. Provide for a clear demarcation between secured and unsecured debts in information and education.
2. Provide information or possibly tools (calculators) to analyze leases and loans for homes, cars, or other secured purchases. Such analysis should be geared toward educating users on the real cost of each option in terms of other opportunities or other options with respect to finance. For example, demonstrate in clear terms, including graphics, the real cost of refinancing to pay off unsecured debt.
3. On the debt as leverage side, show how secured debts differ from unsecured debts, including how with the right asset and leverage, they can be good investments, or, with the wrong formula; the security can be worth less than the liability.

The invention provides calculators and tools helpful in charting a plan and understanding their progress along a plan of debt pay-down, settlement, or wealth building using debt or financial leverage.

This embodiment of the invention comprises the following:
1. Calculators and Tools (offered for free in some embodiments)
   a. Meta-rule: To every extent possible, and where applicable, allow calculators to derive whichever variable is desired, i.e. number of payments, amount of payment, or interest rate, e.g. a missing variable of choice, according to the input data.
   b. Calculate debt-to-equity ratio, which can be automatically calculated as data is entered, or at any point in time. The results can also be stored periodically, e.g. monthly, so that progress in improving the ratio can be charted, as debt is reduced and/or, leveraging debt into assets that appreciate and grow equity, such as the purchase of a home in an appreciating market.
   c. Calculate unsecured debt-to-income ratio, e.g. annual, which can be automatically calculated as data is entered, or at any point in time. The results can also be stored periodically, e.g. monthly, so that progress in improving the ratio can be charted as debt is reduced and/or assets are acquired or grown that produce increasing income revenue.
   d. Calculate secured and unsecured debt pay-down as functions of minimum payments, accelerated payments (user input), or per current budget. Illustrate results with comparative charts.
   e. Calculate accelerated pay-down that shows how quickly all unsecured debt or both secured and unsecured debt can be paid down using a combination of interest reduction and weighted pay-down on higher interest liabilities. Develop an algorithm with the exercise of ordinary skill in the art that provides:
      given a fixed amount of money, with possible increase of available funds over time, what would the quickest pay-down schedule be.
   Provide an alert or query and calculate-on-demand service to notify subscriber when market conditions reported by other subscribers with the same creditor(s) suggest an interest rate reduction may be available which:
      (i) should be pursued, and
      (ii) if successful could change the pay down priorities, as determined by rerunning the algorithm, with all results charted for maximum illustrative impact.
   f. Enter and store income and expenses and, from there, calculate a budget that allows the user to modify any element (increase, decrease, eliminate) or add or delete elements on either side (income or expense) and see what their monthly cash flow is, i.e. positive or negative.
   g. Compound interest calculator for CC debt to illustrate how much of a pay-down is interest and how much is principle, given the input data. Also, graph the result for purposes of understanding and dramatic illustration. Provide a switch to integrate investment opportunity cost, e.g. for a $3,000 bedroom set.
   h. Real-Cost Calculator. Input good/service, cost, interest rate on credit card or revolving account, payment, and compare with opportunity cost of 1a given rate, e.g. 11%, annual compounded for the term of the pay down of the liability.
   i. Wealth Building. Financial leverage calculator. Input initial investment amount, initial value of asset, payments over time and/or maintenance expenses, income received (rental property) any tax adjustments, i.e. mortgage interest deduction or depreciation, expected annual capital appreciation or expected value at a date in the future. Calculate monthly income/loss, and then total ROI and annual ROI. Provide a real-estate investor section, e.g. as a premium service, with all manner of sophisticated decision-making tools.
   j. Wealth Building. Opportunity cost calculator. Input amount of investment or periodic payment, percentage yield of investment or interest rate of debt service, and the expected percentage yield of an alternative investment. Graph the results over time to illustrate the effect of compounding for moderate to high opportunity cost scenarios. Use this calculator or a permutation of it to illustrate what the consumer could save toward some goal by investing the monthly payments that do not go to the credit card company because the consumer has become free of that creditor years a ahead of making variable minimum payments by making fixed payments and/or by making additional payments ahead of schedule. Use this same device to illustrate the power of starting now, i.e. in the same manner that compounding benefits investors who begin early in life. Getting out of debt even a couple of years earlier than normally would be the case can have a profound impact on total assets years into the future, given a solid program of investing.
   k. Wealth Building. Compound interest calculator. Input investment or payment and yield or interest rate. Works for both investments and liabilities. Graph results for understanding and dramatic illustration.
   l. Wealth Building. Investment return calculator. Same as compound interest calculator, but for only the investment side.
2. Calculators and Tools (offered for a premium in some embodiments)
   a. View charts over time of all major banks' (for example, top 50, 100, 200) and what average interest rates they are offering all user subscribers to the site at the time subscribed and, optionally, via surveys or data links it might be able to establish. Cross reference these average rates with things such as income brackets, debt-to-equity ratios, and debt-to-income ratios with comparisons to the users own parameters in these areas. This allows consumers to shop for the best rates, and also provides incentives to improve ratios.
   b. Provide for reporting of credit card solicitations in all their complexity, giving the advantage to issuers with simple and straightforward terms.
   c. Provide a comparison of credit card agreements reflecting items such as overall complexity, late payment charges, remedies for default, monthly service fees applied, sticky clauses such as binding arbitration, etc.
   d. View charts over time of all major banks' willingness to drop interest rates as users use the calculators and tools on the site to get their rates lowered, improve income or ratios, or, even switch to different banks.
   e. View charts over time of all major banks' willingness to settle accounts for less than the full balance, along with sub-charting of the proportion of deals that are paid in six months vs. longer. Volume of settlements should also be a charted parameter.
   f. Use the inventive interface to send, receive, and store faxes to/from creditors via a partner.
   g. Use the inventive interface to send, receive, and store email to/from creditors via a partner.
   h. Use the inventive phone database to contact creditors by phone and log calls with notes.
   i. Use the inventive address database to contact creditors by standard surface mail and log letters with notes.
   j. Locate a partner to provide separate contact phone and voicemail solely for the negotiation process, possibly interfaced through the website using current IP technology.
   k. Provide users a graphical letterhead that is randomized from a set of templates, or customizable, for communication via fax or mail.
   l. Provide a tool for crafting letters according to an impressive set of categories, e.g. settlement offer, hardship notification, confirming letters, etc., in a wizard sort of format with users creating letters in mostly their own words.
   m. Provide pop-ups for certain criteria concerning ratios, creditor mix/amounts, or opportunities, such as high volume of low settlements by creditors they have accounts with, or settlements or interest rate concessions that meet targets set by user.
   n. Email alerts for creditor concessions in settlements and interest rates that meet a target set by the user.
   o. Provide a tool to assist in determining user concession targets by taking into account the user's budget, e.g. monthly debt-pay-down or accumulation for settlements. As funds are available and concession targets are being achieved, alert the user.
   p. Time value of money calculator and chart.
   q. Provide a decision tool to aid users in determining which path is best for them given all relevant inputs.

The preferred embodiment provide graphical representations to chart creditor activity in terms of offers and concessions in interest and principal, as well as user progress for secured debt pay-down, unsecured debt pay-down, total debt pay-down, settlement, or wealth building using debt or financial leverage. The invention also charts, e.g. collection-action rates, arbitration rates, and litigation rates.

This embodiment of the invention comprises the following:
1. Meta-View: Disruption should be the hallmark of everything a website element of the invention is about. It should educate people and provide real and near-real-time data to allow consumers to take maximum advantage of debt. The credit card companies peddle the allure of credit. Consumer advocates proclaim that debt is what it really is, and debt is a four-letter word. One embodiment of the invention provides a website that says that debt is a very powerful wealth-building tool and credit can be taken advantage of.
2. Tied in with all free and premium calculators and tools, as applicable.
3. Provides tools and commentary for chart trend analysis, such as a moving average, which are particularly helpful to debt-settlement programs to aid in timing settlement offers/efforts.
4. Displays the high and low settlements for each day as, by creditor, as well as each individual settlement. As a premium service, provides access to contact information, e.g. name, phone, fax, so that premium members can shop for better deals.
5. Develops charts to show both the current situation, i.e. pay down, in terms of time, total cost and total interest, and also allows display of a hypothetical, e.g. higher payment, reduced interest, etc., and the difference in terms of time, total cost, and interest cost.

One embodiment of the invention provides contact information for creditors, collection agents, and law firms as already exist in the system, and as are added over time from existing customers of both a consumer and commercial side of a website.

This embodiment of the invention comprises the following:
1. Provides a means for users to alert the website as to missing, incorrect, or obsolete contact data in the form of addresses, phone numbers, fax numbers, email addresses, individual contacts, etc.
2. Website support continually monitors and keeps these data as clean and accurate as possible.

As a premium service, the invention provides communications tools and portals, such as email and fax, so that users may communicate in writing with creditors, collection agents, and law firms using the inventive interface.

This embodiment of the invention comprises the following:
1. Establishes partnerships with email and fax providers for both send and receive.
2. Allow all communications to be associated with a particular case so that the user can maintain a record of communications:
   a. Retain all sent items and associate them with the case they are sent in relation to.
   b. Users may scan, upload, and file communications they receive from creditors, collectors, and law firms.
3. Users can create their own letterhead by selecting a template, modifying a template, or creating one from scratch. They can then compose letters for printing or faxing on this letterhead.
4. Provide a collection of canned but editable letters for various communications related to negotiating interest rate reductions, settlement, or other concessions.

The invention provides complete education in the nature of debt, both secured and unsecured, as well as the means by which one can reduce/eliminate debt, as well as the general and specific procedures for doing so in both a pay off over time situation, settlement situation, or a combination strategy. The invention also provides education in the process of wealth building, using debt or financial leverage.

The invention provides motivational feedback to users in the form of credit-industry news that is judged to be helpful to their cause in some way: either as attacks on the credit industry in general, such as lawsuits, or other forms of news that bolster the perception that credit is something to be wary of and control. Highlight successes in wealth building using debt or financial leverage. The aim here is to keep the website always fresh and relevant. Everyday something new is happening and there are new opportunities or things to be aware of or cautious about.

The invention provides additional motivational feedback to users in the form of general facts and figures regarding settlements already achieved and continues to be achieve by other website subscribers and subscribers to hosted systems.

This embodiment of the invention comprises the following:
1. Provides summary reports, by creditor, and cross-referenced by different parameters such as income levels, total debt levels, debt-to-income ratios, debt-to-equity ratios, net worth, etc.
2. Charts the data, providing analysis such as moving averages.
3. As a premium service, provides pop-up and email alerts relevant to subscriber's own situations, e.g. “a subscriber just negotiated a 20% settlement with Citibank.” Alerts can also be used for interest rate reductions, other concessions, or any sort of noteworthy news. The website staff also generate alerts and transmits them to subscribers who meet certain parameters. This feature could be a main selling point for hosted systems, the attraction being that debt-settlement companies could benefit from the successes of other companies, but without giving away any secrets.

The following additional features of the invention are thought to be necessary for superior functionality of the invention:
1. Creation of cases for each creditor and tracking the life cycle of the settlement interactions with that creditor that include logging notes.
2. Agent functionality. Assigning agents to clients and tracking agents' performance, adding and deleting agents, i.e. an intelligent agent module.
3. Doing the amortization calculations for mortgage and credit card.
4. Customized debt pay-down calculator.
5. Send email attachments of the filled forms from the application by the user to the creditor.
6. Capturing such activities as deposits of EFT, email interactions, faxes, etc.
7. Ability to send electronic documents as a fax to the creditor. Categorize these as a settlement offer, hardship notification, confirming letters, etc.
8. Set target notifications for interest rate changes/concessions.
9. Settlement changes of the creditor since establishing a debt pay-down plan. Accumulation of targets dollars in the account.
10. Credit mix amounts, Alert on targets reached.
11. Automatic listing of creditors of the user in a list credits grid.
12. If the interest rates have gone down based on other consumer inputs, alert the consumer when logged in or by email notification.
13. Integration of mortgage rates.
14. Consumer can add relevant notes when talking to the creditor.
15. Use an address database to contact creditors by surface mail and log letters with notes.
16. Identify interest rate reduction, late fee reduction and calculate the optimal pay down priorities based on those changes.
17. Compound Interest Calculator, Real Cost Calculator, Financial Leverage Calculator, Opportunity Cost Calculator, and Investment Return Calculator.
18. Search Function: Willing to settle by banks, search and identify the correct credit card for the consumer, establish a negotiating partner.
19. Generate letter heads from templates to be used by the consumer and auto-creating letters using templates.
20. Wizard navigator for quality for online processing.
21. Credit card input screen.
22. Lookup for credit card.
23. Lookup for specialty accounts.

The invention also comprises a wizard that pre-qualifies debt settlement clientele by using the following criteria:
1. At least three credit cards;
2. Loan amount is $10000 or more;
3. No credit card constitutes 60% of the total loan; and
4. Credit cards chosen may fall into specialty cards and, if so, if their total loans from specialty should be less than 40% of the total loan.

The invention also comprises a wizard like tool that navigates through different input pages and automates the process of generating dynamic pdfs for the applicant and co Applicant to be sent to the client using email or surface mail. This feature officially enrolls the applicant in the inventive debt settlement program.

The following is an itemized list of functionality required for this tool.
1. Enrollment application (applicant, co-applicant, co-debtor)—signature needed
2. Financial Statement (Dependents, Gross Income, Payroll Deductions)
3. Expenses
4. Total Assets
5. Creditor List
6. Applicant and Spouse/Co-Applicant Settlement Saving Account
7. EFT Authorization—signature needed
8. Monthly Payment Work Sheet
9. Limited Power of Attorney (applicant and co-applicant)—signature needed
10. CFG (Information and Application)—signature needed
11. Note of Rescission—signature needed
12. Spousal Acknowledgment—signature needed
13. Special Creditor Acknowledgement—signature needed
14. Employee Sponsored Credit Car Disclosure—signature needed
15. Non Qualified Credit Card Disclosure—signature needed
16. Applicant/co-applicant Acknowledgement—signature needed
17. Senior Acknowledgement—signature needed
18. Client Info
19. Creditor Call Log

One embodiment of the invention converts dynamic html forms filled in by the user to a PDF that is sent to the user for signature authorization, for those items that require signature.

API Module

The API module defines interfaces and implements the modules that exist as interfaces. This allows new implementer(s) to mix and match what they want and provides a plug-in for modules that require changes.

In the present embodiment, the following functionalities from a current application can be plugged into a foreign application:
1. Login Module (Create, Forgot password, Edit Profile)
2. Loan Budget Input Module (Input and Save: Income, Expenses, Secured Loans and Unsecured Loans)
3. Loan Budget Analyzer (Analyze Income to Debt, Income to Expense, Secured to Unsecured, Debt Pay-down Analysis)
4. Creditor Module (Look up a Creditor, Create a Creditor, Import Creditor Information)
5. Creditor Settlement Module (Query against settlements to come up with the Proposed Loan Settlement, Import Creditor Settlements)
6. Form Upload Module (Look up existing canned letters with a download function)
7. Payment Gateway
8. Agent Module
9. Notification Module
   Architecture

The invention resides in an architecture comprises of five general modules:
1. Marketing.
2. Subscription/Point of Sale.
3. Education/Instructions.
4. Help Support/Customer Service.
5. Debt-Settlement Tool.

Marketing

In the area of marketing, that part of the website that is currently a free information site that contains articles indexed by search engines to drive traffic to the site. In addition, various means are provided to encourage people to consider a paid service, including a requirement to register for the free information so that there can be a follow-up with periodic emails and/or other promotions that advertise the paid service. This is intended to be a flexible area that can have new content added at will, and also dynamic in the sense that it may contain landing-page portals fed from a variety of different sources throughout the web. Flexibility with regard to change, updating, and modification is a prime element for this module.

Another core function in this area of the website is a tutorial/overview presentation. This is a streaming audio/graphical presentation designed to present the essential aspects of an Education/instructions section and a Debt-Settlement Tools section in the context of inducing people to enroll and pay for the service.

Registration/Point of sale

This section bear no essential difference from the way such a thing exists in tens of thousands of websites around the world. The user creates an account, sets up a user-name and password, and pays.

Education/Instructions

This area is the first of two areas within the paid-service portion of the website. This includes, but is not limited to the following “How To” sub-sections:
1. Get set up. This explains everything a subscriber should know about getting set up and ready to go. The subscriber must enter all of his unsecured debts that he intends to place into the program, along with most recent balances, contact information that is available, etc. It discusses numerous ground rules, risks, and induces the subscriber to write up a hardship description.
2. Use the Debt-Settlement Tool. This gives an overview of the tools, by bookmarked section to provide context-sensitive help links in and around the various tools.
3. Communicate with creditors. Describes the various aspects of how written and verbal communication with creditors should be approached for maximum effectiveness.
4. Negotiate. Instruction in the basic aspects of debt negotiation, without getting too complex.
5. Close deals and get the paperwork right.
6. FAQ. Begin with a dozen or so likely common questions and build from there in response to new questions.

Help Support/Customer Service

Adopts a standard interface for submitting trouble issues to customer service. This also provides an access point to a premium service that allows subscribers to submit questions concerning their dealings with creditors or collectors.

Debt-Settlement Tool

The debt-settlement tool or database itself should consist of the following areas or elements:

Data Entity

For each unsecured debt. To maintain integrity between the settlements by a related service, as well as the settlements done by other subscribers to the website, the company names of all creditors, collection agencies, and collection law firms need to have an unique ID assigned to them, e.g. use existing ID numbers. As such, subscribers must use an existing creditor or collector company name when entering data. If the name they are looking for does not exist, they must submit a request through the help support portal that a new entity be added. Such additions must propagate back to system, but in one embodiment, both the settlement data and any additional creditors entered in website can be done by simple file import/export.

In addition, there must be at least two data fields pertaining to the subscriber (see Table 4): Current Settlement Funds Available and Regular Monthly Budget for Additional Funds. These two pieces of data are all that are required to calculate all settlement projections for the client based on recent actual settlement results. Table 5 below is meant to address all data requirements, not present any particular order, format, or scale whatsoever.

TABLE 4

| | |
|---|---|
| Current Settlement Funds | Regular Monthly Budget for Additional Funds |
| Available | |

TABLE 5

| Creditor Name | Creditor Address | City | State | Zip |
|---|---|---|---|---|
| Phone | Fax | Balance | Date Balance | |
| | | Owed | Owed | |
| Collection | Collector | City | State | Zip |
| Agent | Address | | | |
| Phone | Fax | | | Add Account |

Main Summary Screen

Two summary tables (see Tables 6 and 7 below), the first showing the client's current settlement funds and monthly budget for additional funds (both editable) with all the calculations pertaining, and a second showing a listing of each account, along with specifics as to its current status in terms of pending offers, settlements, and such. This is also the primary jumping off point for bringing up editable forms/tables such:
1. Each creditor account separately, with complete contact information and log note history.
2. Log note history separately.

3. Data and graphical representations as to the number, amount, dates, and average settlements for this particular creditor.

TABLE 6

| Current | Monthly | Total Original | Total Current | Funds % of |
|---|---|---|---|---|
| Funds | Budget | Balance | Balance | Original |
| Funds % of | Estimated | Funds % | Estimated | Estimated |
| Current | Cost | Estimated | Months | Completion |
| | | Cost | | |

TABLE 7

| | | | | Current |
|---|---|---|---|---|
| [Open] | | Agent Name | Original | Claimed |
| [Notes] | Creditor Name | (if applicable) | Balance | Balance |
| Offer or | Estimated | % Available | Months | Estimated |
| Final | Settlement | (est stlmt) | to | Available Date |
| Settlement | | | Available | (est stlmt) |
| | | | (est | |
| | | | stlmt) | |
| Collection | Counter Offer | % Available | Months | Estimated |
| Status | (if applicable) | (counter) | to | Available Date |
| | | | Available | (counter) |
| | | | (counter) | |

As a whole, each row (or two rows, if needed for each record) can be color-coded as follows:
None: a regular open case.
Blue: a settled case, open (pending completion of settlement) or closed.
Grey: closed, unsettled.
Yellow: open, unsettled, where the Current funds as a percentage of Current Claimed Balance>the lowest percentage settlement reported for this creditor within the last three months.
Green: open, unsettled, where the Current funds as a percentage of Current Claimed Balance>the Estimated Settlement as a percentage of Current Claimed Balance.
Red: open, unsettled, where the Current funds as a percentage of Current Claimed Balance>the highest percentage settlement reported for this creditor within the last three months.
   Settlement Reports

These reports are comprised of all settlement data from the system, as well as all subscribers to the website. This area is open to data as to the number, amounts, dates, and averages for all settlements in total. The data can be viewed over any date range or date, can be selected for any creditor or collection agent, or classified as to type of settlement or combination of collection status: Normal, Agent, Law Firm, Litigation, Judgment.

In general, the data should cover:
1. Lowest settlement over the date range.
2. Highest settlement over the date range.
3. Median settlement over the date range.
4. Mean average settlement over the date range.
5. A graphical plot of all settlements in the data range.
   a. Scatter plot.
   b. Low, High, and Average for each day that settlements took place (analogous to the low, high, and close ticks and bars on a stock chart)
      Canned Letters

These allow for the creation of a basic letterhead by each subscriber that is saved, and upon which can be applied canned text that is provided by the website. They allow for editing and/or adding/deleting text prior to saving and printing for mailing, faxing, or copy/paste for emailing; and provide for administrative editing, adding, and deleting of canned text and appropriate index modification.

Use Cases

TABLE 8

| Use Cases | Comments | Attributes |
|---|---|---|
| Login | Ability to login to secure web | |
| | site. | |
| Consumer should | Should use the standard http and | consumer.username, |
| have a secure access | https protocols. | consumer.password |
| to the system | | |
| Forgot Password | Ability to send the password to | |
| | consumers email if proper hints | |
| | are provided. | |
| Incorrect Password or | Should be redirected to the same | |
| User Name | login page with the correct error | |
| | message. | |
| Reset Password | Password should be resettable | Password |
| | by the consumer. | Create/Modify Date. |
| Logout | Should take the user back to the | |
| | login page. | |
| Consumer | Consumer Information | |
| Login | Uses the login module | consumer.username, |
| | | consumer.password, |
| | | consumer.question, |
| | | consumer.hint |
| Profile | General information about the | firstname, lastname, |
| | consumer and spouse. Create | salutation, email, |
| | and Update. | mobilephone, pager, |
| | | fax, homeaddress |
| | | (street, city, state and |
| | | zip), home phone and notes. |
| Employment | Information about the consumers | officeaddress (address, |
| | job. A consumer can have more | city, state and zip), |
| | than one job | phone, fax, pager, |
| | | email), |
| | | fulltime/parttime/contract |
| Income | A consumer can have more than | Name, amount, period |
| | one income. In the case of a | (hourly, weekly, bi- |
| | joint consumer (consumer and | weekly, monthly) |
| | spouse) it may be necessary to | |
| | maintain the income as joint. | |
| Assets | A consumer can have more than | Name, Type, Value |
| | one asset. Need to categorize | |
| | Assets (Automobiles, Property, | |
| | Bank Savings, Checking, Stocks, | |
| | Bonds, Mutual Funds, 401K, 529, | |
| | IRA, Insurance Policy value etc.). | |
| Expenses | A consumer can have more than | Name, Type, Amount, |
| | one expense(Mortgage, | period (weekly, bi- |
| | automobile, home insurance, | weekly, monthly, |
| | earthquake insurance, flood | quarterly) |
| | insurance, umbrella Policy, Food | |
| | Expenses, Dining out, Electricity, | |
| | Water, Garbage, News Paper, | |
| | Gas, House Needs, Gardening, | |
| | Miscellaneous etc.). | |
| Liabilities | A consumer can have more than | Name, accountid, |
| | one liability (Credit Cards etc.) | duedate, amount, |
| | | minimum payment, late |
| | | fees, annual fees, |
| | | address(street, city, |
| | | state and zip), phone, |
| | | fax, hasWebAccess, |
| | | username, password. |
| Categorization of | Auto Calculate the secured vs. | |
| debts | unsecured debts. Give the ability | |
| | to the consumer to change and | |
| | re categorize. | |
| Add Business Rule | Ability to set notification alert or | |
| | flash alert (on login) to the | |
| | consumer on a variable set of | |
| | parameters which include | |
| | payment due date, change in | |
| | creditors fee structure or rate at | |
| | which they charge, reach user | |
| | target budgets, credit mix up etc. | |
| Set Target | Pop-ups for certain criteria | |
| Notifications for | concerning ratios, creditor | |
| Interest rate | mix/amounts, or opportunities, | |
| changes/concessions, | such as high volume of low | |
| Settlement changes | settlements by creditors they | |
| of the creditor since | have accounts with, or | |
| establishing a debt | settlements or interest rate | |
| pay down plan. | concessions that meet targets | |
| Accumulation of | set by user. The Notification | |
| Targets dollars in the | engine should detect these and | |
| account. Credit mix | intelligently add flash activities. | |
| amounts etc. | Also set Target User Budgets | |
| | and notify, if achieved. | |
| Detect Flash Activity | If the interest rates have gone | |
| | down based on other consumers, | |
| | input alert the consumer when | |
| | logged in or by email notification. | |
| Send and Receive | Ability to send electronic | |
| Fax from Creditor | documents as fax to the creditor. | |
| | Categorize as settlement offer, | |
| | hardship notification, confirming | |
| | letters, etc.). | |
| Send and Receive | Ability to send emails to the | |
| emails to and from | creditor. Categorize as | |
| the Creditor | settlement offer, hardship | |
| | notification, confirming letters, | |
| | etc.). | |
| Add Notes | Consumer should be able to add | |
| | relevant notes when talking to the | |
| | consumer. | |
| Incorporate | Consumer should be able to | |
| Calculated Debt to | track the different parameters | |
| equity ratio, | over the period of the pay down | |
| unsecured debt to | cycle and beyond. | |
| income ratio as | | |
| metrics that is being | | |
| tracked over the | | |
| period of the debt pay | | |
| down cycle. | | |
| Use the system | Do they need to print and have | |
| address database to | us do the mailing for them? | |
| contact creditors by | | |
| surface mail and log | | |
| letters with notes | | |
| Admin Console | Administrator to configure the | |
| | system | |
| Agent Related | This functionality is required | |
| | only if the Agent is involved. | |
| Add Agent | Add an agent | Agent Id, Password |
| Modify Agent | Modify an agents attributes | |
| | including resetting the password | |
| Deactivate Agent | Mark an agent as deactivated | |
| Associate | Associate consumer(s) to an | |
| Consumer(s) to a | agent as the primary negotiator. | |
| primary Agent. | | |
| Business Rule Engine | Notification engine login | login name, login |
| Login Credentials | attributes. | password |
| Modify the Home | Global way to change the Home | |
| Page | page of the website. | |
| Modify the Consumer | Global way to change the | |
| Home Page | Consumer dashboard page. | |
| Calculators and | | |
| Tools | | |
| Free Service | | |
| Unsecured debt-to- | | |
| Income Ratio | | |
| Debt-to-Equity Ratio | | |
| Secured and | Need to show as a chart. Need to | |
| Unsecured Debt pay | identify the chart control that we | |
| down Analysis. | need to use. Should support pie, | |
| Should be able to | chart, 3d, Gantt etc. Need to | |
| suggest the optimal | track on a month to month basis. | |
| payment path for | | |
| earlier debt pay | | |
| down. | | |
| Identify interest rate | This is reported by other | |
| reduction, late fees | consumers who use the same | |
| reduction and | creditors. | |
| Calculate the optimal | | |
| pay down priorities | | |
| based on those | | |
| changes. | | |
| Income and Expense | Income and expenses can be | |
| calculator | changed to analyze the cash flow | |
| | and calculate the monthly cash | |
| | flow positive or negative. | |
| Compound Interest | Help analyze how much is | |
| calculator | principle and how much is | |
| | interest for a given input data. | |
| | Need a chart analysis. Has to | |
| | suggest investment opportunity | |
| | on a positive cash flow. | |
| Real Cost Calculator | Need information on what the | |
| | difference between this and the | |
| | compound interest rate | |
| | calculator. | |
| Wealth Calculator | | |
| Financial Leverage | Input: Initial Investment amount, | |
| Calculator | initial value of asset, payments | |
| | over time, maintenance | |
| | expenses, income received | |
| | (rentals), tax | |
| | adjustments(mortgage interest | |
| | reduction or depreciation) | |
| | expected capital appreciation at | |
| | a date in future. Output: Monthly | |
| | income/loss and total ROI and | |
| | annual ROI. | |
| Opportunity Cost | Input amount of investment or | |
| Calculator | periodic payment, percentage | |
| | yield of investment or interest | |
| | rate of debt service, and the | |
| | expected percentage yield of an | |
| | alternative investment. Graph the | |
| | results over time to illustrate the | |
| | effect of compounding for | |
| | moderate to high opportunity cost | |
| | scenarios. Use this calculator or | |
| | a permutation of it to illustrate | |
| | what the consumer could save | |
| | toward some goal by investing | |
| | the monthly payments that do not | |
| | go to the credit card company | |
| | because the consumer has | |
| | become free of that creditor | |
| | years a ahead of making variable | |
| | minimum payments by making | |
| | fixed payments and/or by making | |
| | additional payments ahead of | |
| | schedule. Use this same device | |
| | to illustrate the power of starting | |
| | now, i.e. in the same manner that | |
| | compounding benefits investors | |
| | who begin early in life. Getting | |
| | out of debt even a couple of | |
| | years earlier than normally would | |
| | be the case can have a profound | |
| | impact on total assets years into | |
| | the future, given a solid program | |
| | of investing | |
| Compound Interest | Inputs: Investment or payment | |
| calculator | and yield or interest rate. Work | |
| | for both investments and | |
| | liabilities. Need a graph. | |
| Investment Return | Investment return calculator. | |
| Calculator | Same as Compound interest | |
| | calculator but only for investment | |
| | side. | |
| Premium | | |
| Search Banks for | It would use the system | |
| interest rates and | database and knowledge based | |
| categorize according | on what consumers pay for | |
| to the debt equity | different kinds of banks. This is | |
| ratio, income | not a live feed. | |
| brackets, debt-to- | | |
| income ratio. | | |
| Search | | |
| Banks/creditors to | | |
| identify which one | | |
| has a tendency to | | |
| drop rates. | | |
| Provide for reporting | Need content. | |
| of credit card | | |
| solicitations in all their | | |
| complexity, giving the | | |
| advantage to issuers | | |
| with simple and | | |
| straightforward terms | | |
| Search Willing to | Search banks major banks' | |
| settle by Banks. The | willingness to settle accounts for | |
| invention informs the | less than the full balance, along | |
| subscribers how to | with sub-charting of the | |
| negotiate settlement | proportion of deals that are paid | |
| amounts based upon | in six months vs. longer. Volume | |
| settlement history | of settlements should also be a | |
| contained in the | charted parameter. It would use | |
| system. | a database and knowledge | |
| | based on what consumers pay | |
| | for different kinds of banks. This | |
| | is not a live feed. | |
| Search and identify | Provide a comparison of credit | |
| the correct credit card | card agreements reflecting items | |
| for the consumer | such as overall complexity, late | |
| | payment charges, remedies for | |
| | default, monthly service fees | |
| | applied, sticky clauses such as | |
| | binding arbitration. It would use | |
| | the system database and | |
| | knowledge based on what | |
| | consumers pay for different kinds | |
| | of banks. This is not a live feed. | |
| Establish a | Locate a partner to provide | |
| negotiating Partner. | separate contact phone and | |
| | voicemail solely for the | |
| | negotiation process, possibly | |
| | interfaced through the website | |
| | using some of the latest IP | |
| | technology. | |
| Generate letterheads | Provide users a graphical | |
| from templates to be | letterhead (randomized from a | |
| used by consumer. | set of templates, or | |
| | customizable) for communication | |
| | via fax or mail. | |
| Create Letters using | Provide a tool for crafting letters | |
| Templates. | according to an impressive set of | |
| | categories (settlement offer, | |
| | hardship notification, confirming | |
| | letters, etc.) in a wizard sort of | |
| | format with users creating letters | |
| | in mostly their own words. | |
| Time Value of Money | | |
| Tools to help in debt | Develop tools and commentary | |
| settlement programs. | for chart trend analysis, such as | |
| | a moving average, which are | |
| | particularly helpful to debt- | |
| | settlement programs to aid in | |
| | timing settlement offers/efforts. | |
| Identify Best | Display the high and low | |
| settlement deals on a | settlements for each day as, by | |
| day to day basis. | creditor, as well as each | |
| | individual settlement. As a | |
| | premium service, consider | |
| | providing access to contact | |
| | information (name, phone, fax) | |
| | so that premium members might | |
| | be able to shop for better deals. | |
| Calculate hypothetical | Develop charts to show both the | |
| payment models | current situation (pay down) in | |
| based on reduced | terms of time, total cost and total | |
| interest rate or higher | interest, and also allow display of | |
| payment. | a hypothetical (higher payment, | |
| | reduced interest, etc.) and the | |
| | difference in terms of time, total | |
| | cost, and interest cost. | |
| Notification | A service based process. This | |
| Manager | process runs on the background, | |
| | wakes up on a periodic basis and | |
| | does the following. For all | |
| | consumers who have dues to be | |
| | paid send an alert. Detect if paid | |
| | and add an activity that it is paid. | |
| Interest Rate | Detect Interest rate reductions for | |
| Reductions | the consumers for all the credit | |
| | cards they have and create a | |
| | flash which the consumer sees | |
| | when they first login since the | |
| | activity occurred or send an email | |
| | based on preference. | |
| Alert on Targets | Availability of funds based on | |
| reached | their target goals set | |
| | Provide a means for users to | |
| | alert the website as to missing, | |
| | incorrect, or obsolete contact | |
| | data in the form of addresses, | |
| | phone numbers, fax numbers, | |
| | email addresses, individual | |
| | contacts, etc. This is kept intact | |
| | by having required fields as part | |
| | of creation. | |
| | Website support continually | |
| | monitors and keeps this data as | |
| | clean and accurate as possible. | |
| Import of Data | Export data and tables from | |
| | Access and Import to mySql. | |

### EXAMPLE

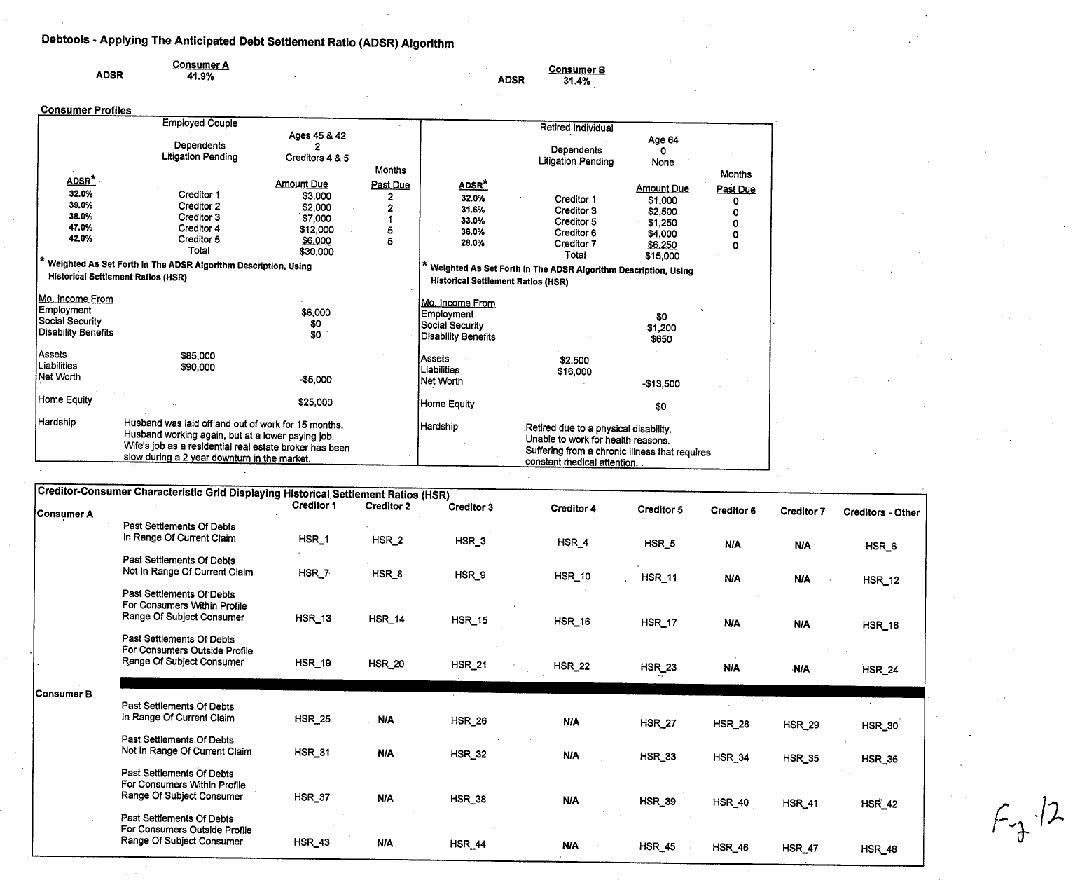

FIG. 12.is a spreadsheet showing the results of applying the ADSR algorithm to two consumers having disparate sets of circumstances. In FIG. 12, two consumer profiles are shown, one for Consumer A, an employed couple with two dependents, and one for Consumer B; a retired individual having no dependents. Each profile provides a hardship narrative. Also provided for each consumer is a Creditor-Consumer Characteristic Grid Displaying Historical Settlement Ratios (HSR). Based upon the profile information, as applied to the HSR, an ADSR is calculated which, for Consumer A is 41.9%, while for Consumer B the ADSR is 31.4%. These percentages indicate the effective compromise on indebtedness Consumer A and Consumer B would expect to achieve in accordance with the invention.

Although the invention is described herein with reference to the preferred embodiment, one skilled in the art will readily appreciate that other applications may be substituted for those set forth herein without departing from the spirit and scope of the present invention. Accordingly, the invention should only be limited by the Claims included below.

1. A computer implemented method for settling of consumer debts, comprising the steps of:
providing consumers with recent settlement histories of the consumers' creditors via a web-hosted application; and
providing said consumers with means for using knowledge of said settlement histories to settle their debts.

2. The method of claim 1, said step of providing said consumers with means for using knowledge of said settlement histories comprising the step of either providing means for said consumers conducting a settlement process via web-hosted application or providing a full-service application that conducts a settlement process on behalf of consumers.

3. A computer implemented method for settling of consumer debts, comprising the steps of:
providing debtors with knowledge in advance concerning how much credit card companies may take to settle their debts in view of the debtors' financial hardships; and
providing said debtors with means for settling their debts at discounts equivalent to those that professional negotiators could achieve.

4. The method of claim 3, further comprising the steps of:
aggregating information concerning actual settlement experience from thousands of consumer accounts settled with creditors;
evaluating key characteristics of consumers, said consumers' creditors, an account settled, and actual settlement terms;
analyzing relationships among key characteristics to draw inferences as predictors of creditors' future settlement behavior; and
recommending to consumers a set of expectations to guide their settlement negotiations with each of their creditors based upon results of said analyzing step.

5. The method of claim.4, further comprising the step of:
providing consumers online tools for any of:
organizing and recording information required to conduct debt settlement negotiations;
identifying current creditor contacts who can negotiate debt settlements;
creating a record of communications with creditors during the debt settlement negotiation process; and
comparing tested settlement and related document templates to actual documentation supplied by creditors in the debt settlement negotiation process.

6. The method of claim 4, further comprising the step of:
documenting actual debt settlements negotiated to conclusion by consumers for any of:
providing consumers with a fail-safe mechanism to record their settlements and to recover documentation reflecting those settlements if needed for future verification; and
updating aggregation of information concerning actual settlement experience from other consumer accounts settled with creditors with additional and continually current new settlement information.

7. The method of claim 4, further comprising the step of:
providing consumers working toward becoming debt free with online resources for any of:
tabulating and evaluating their progress;
general financial planning reference;
budgeting; and wealth building.

8. The method of claim 4, further comprising the step of:
automatically converting a consumer's online debt settlement negotiating database to a full-service debt settlement program if the consumer finds negotiating directly with creditors to be unduly confusing or difficult, personally unsettling, or unproductive.

9. The method of claim 4, further comprising the step of:
providing a website comprising computer implemented tools for settling debt.

10. The method of claim 9, further comprising the step of:
said consumer entering a set of information that is used to classify the consumer with regard to such factors a risk of bankruptcy and other factors that are considered by a lender or credit provider when compromising upon amounts owed.

11. The method of claim 9, further comprising the step of:
providing said consumer with at least one illustration showing a likelihood of settling said consumer's debt.

12. The method of claim 10, said illustration comprising any of:
a debt-to-income ratio which indicates that the consumer should get financial help immediately to reduce debt aggressively;
information showing an unsecured/secured debt ratio; and
a debt settlement ratio which shows the consumer experience-based settlement ratios for various creditors, wherein the consumer is provided with an anticipated settlement amount and an effective anticipated settlement ratio.

13. The method of claim 9, further comprising the step of:
providing a case list of creditors and their respective claims.

14. The method of claim 9, further comprising the step of:
providing an employment hardship a field for said consumer to enter a narrative describing the consumer's circumstances.

15. The method of claim 9, further comprising the step of:
providing a plurality of canned letters organized by category for use by said consumer.

16. A computer implemented method for settling of consumer debts, comprising the steps of:
providing a consumer with a website for settling of consumer debts;
optionally offering the consumer free financial check-up (FFC) including information about any of the consumer's income, expenses, assets, and secured and unsecured liabilities (93);
analyzing the consumer's input and produces an FFC output including any of a debt-to-income ratio, secured/unsecured debt allocation, an aggregate debt settlement ratio that is anticipated for all unsecured debts (ADSR), and a financial outlook recommendation.

17. The method of claim 16, wherein said FFC output comprises any of:
recommending that the consumer maintain status quo and periodically visit the website;
recommending an accelerated loan principal reduction (ALPR), wherein the consumer registers for ALPR and the FFC input previously entered by the consumer is automatically transferred for processing as an ALPR output, wherein the consumer is then provided with information comprising any of amortization comparisons, the effect of making minimum payments vs. fixed payments vs. extra payments, the effect of making accelerated payments to one creditor vs. another creditor, and strategies for the shortest time to total payoff of debt; and
recommending debt settlement, wherein the consumer registers for debt settlement and the FFC input previously entered by the consumer is automatically transferred for processing, wherein the consumer adds profile information and receives an ADSR, and wherein the consumer can settle his debts using the ADSR and a debt management customer relations management (CRM) system, the consumer having the option of completing the process of settling all debts or the consumer can decide not to finish settling all debts directly and can, instead, enroll in a debt management program with a full service company, in which event all of the consumer's information is automatically transferred to the full service company.

18. An apparatus for determining an aggregate debt settlement ratio (ADSR), comprising:
a Debt Settlement Database;
a Consumer Database;
wherein said Debt Settlement Database and said Consumer Database associate debt settlements and consumers owing the debts settled; and
an ADSR Algorithm for determining said ADSR by comparing:
characteristics of debt in question to other debts actually settled by a creditor holding the debt in question, and
characteristics of the debt in question to similar debts actually settled by other Creditors, and
characteristics of a consumer owing the debt in question to other consumers whose debts were settled by the creditor holding the debt in question, and
characteristics of the consumer owing the debt in question to similar consumers whose debts were settled by other creditors.

19. The apparatus of claim 18, wherein settlement ratios of the comparison settled debts are weighted according to relevance of characteristic selectors, and wherein said weighted ratios are then summed to produce the ADSR for the debt in question.

20. The apparatus of claim 19, wherein said relevance is determined by a continuing comparison of an actual settlement ratio for a debt and the ADSR for the same debt, derived in part by the effect of the relevance factor applied in determining the ADSR for the debt in question.

21. The apparatus of claim 18, further comprising:
one or more calculators and tools for any of:
calculating debt-to-equity ratio;
calculating unsecured debt-to-income ratio;
calculating secured and unsecured debt pay-down as functions of minimum payments, accelerated payments (user input), or per current budget;
calculating accelerated pay-down that shows how quickly all unsecured debt or both secured and unsecured debt can be paid down using a combination of interest reduction and weighted pay-down on higher interest liabilities
providing an alert or query and calculate-on-demand service to notify a consumer when market conditions reported by other consumers with the same creditor(s) suggest an interest rate reduction may be available, which should be pursued and, if successful, could change the consumer's pay down priorities;
entering and storing income and expenses and, from there, calculating a budget that allows the consumer to modify any element (increase, decrease, eliminate) or add or delete elements on either side (income or expense) and see what their monthly cash flow is;
providing a compound interest calculator for CC debt to illustrate how much of a pay-down is interest and how much is principle;
providing a real-cost calculator;
providing a financial leverage calculator.;
providing an opportunity cost calculator;
providing a compound interest calculator;
providing an investment return calculator;
viewing charts over time of major banks and what average interest rates they are offering others, cross referenced with any of income brackets, debt-to-equity ratios, and debt-to-income ratios with comparisons to said consumer's own parameters in these areas;
reporting of credit card solicitations;
providing a comparison of credit card agreements, including any of overall complexity, late payment charges, remedies for default, monthly service fees applied, and sticky clauses;
viewing charts over time of major banks' willingness to drop interest rates as consumers get their rates lowered, improve income or ratios, or switch to different banks;
viewing charts over time of major banks' willingness to settle accounts for less than the full balance, along with sub-charting of a proportion of deals that are paid in six months vs. longer;
sending, receiving, and storing faxes to/from creditors via a partner;
sending, receiving, and storing email to/from creditors via a partner;
using a phone database to contact creditors by phone and log calls with notes;
using an address database to contact creditors by standard surface mail and log letters with notes;
locating a partner to provide separate contact phone and voicemail solely for a negotiation process;
a graphical letterhead that is randomized from a set of templates, or customizable, for communication via fax or mail;
a tool for crafting letters according to a set of categories;
pop-ups for certain criteria concerning ratios, creditor mix/amounts, or opportunities, including any of high volume of low settlements by creditors they have accounts with, or settlements or interest rate concessions that meet targets set by the consumer;
email alerts for creditor concessions in settlements and interest rates that meet a target set by the consumer;
determining consumer concession targets by taking into account the consumer's budget;
time value of money calculator and chart; and
a decision tool to aid consumers in determining which path is best for them given all relevant inputs.

22. The apparatus of claim 18, further comprising:
means for providing graphical representations to chart creditor activity in terms of offers and concessions in interest and principal, as well as any of consumer progress for secured debt pay-down, unsecured debt pay-down, total debt pay-down, settlement, wealth building using debt or financial leverage, and any of collection-action rates, arbitration rates, and litigation rates.
